(19) United States
(12) Patent Application Publication
(10) Pub. No.: US 2009/0142978 A1
(43) Pub. Date: Jun. 4, 2009

(54) Anorganic mixed fiber product with anorganic fiber flakes and glass wool fibers

(75) Inventors: Jens Meyer (Deceased), Hirschberg (DE); Thomas Weigert, Plaine, PA (US); Anton Zysik, Kurten (DE)

Correspondence Address: THE NATH LAW GROUP, 112 South West Street, Alexandria, VA, 22314, US

(73) Assignee: Saint-Gobain Isover G+H AG, Ludwigshafen (DE)

(21) Appl. No.: 11/990,850

(22) PCT Filed: Aug. 23, 2006
(86) PCT No.: PCT/EP2006/008292

§ 371 Date: Jul. 8, 2008

(30) Foreign Application Priority Data
Aug. 24, 2005 (DE) 102005040076.0

(51) Int. Cl. B32B 5/08; D01D 5/08

(52) U.S. Cl. 442/60; 442/172; 264/172.17; 425/224

(57) ABSTRACT

The present invention for the first time proposes an anorganic mixed fiber product having good insulation properties and good fire stability, wherein the anorganic mixed fiber product comprises both glass fibers (23) and anorganic fiber flakes (25), and wherein the anorganic fiber flakes (25) are disposed substantially homogeneously between the glass fibers (23). The present invention moreover proposes a method for manufacturing the anorganic mixed fiber product of the invention, as well as an apparatus (1) for implementing the method of the invention. The invention further proposes a product manufactured of the anorganic mixed fiber product of the invention and an apparatus for carrying out the method in accordance with the invention.

The present invention concerns an anorganic mixed fiber product comprising both glass wool and anorganic fiber flakes which, according to the invention, may also be a mineral wool, in accordance with claim 1, as well as a method for manufacturing this anorganic mixed fiber product in accordance with claim 9. The invention further concerns products in accordance with claims 8 and 15 that were manufactured by using the anorganic mixed fiber product of the invention or the method of the invention, and an apparatus in accordance with claim 16 for implementing the method of the invention.

From practice two kinds of mineral wool products are known. On the one hand glass wool products are known which are essentially comprised of glass wool fibers and exhibit good insulation properties due to the glass wool fibers. Moreover rock wool products are known which essentially comprise rock wool fibers and are accordingly characterized by a particularly good temperature resistance, in particular a fusion point in excess of 1000° C. (determined in accordance with German Industrial Standard DIN 4102 Part 17) and a particular resistance against the influence of fire in the case of a fire.

In practice, several—sometimes incompatible—demands are made to an insulation, where a weighting of the individual demands depends on the intended use. Thus it is possible that a fusion point of more than 1000° C. at concurrently a best possible insulation may be demanded for various applications of mineral wool insulation materials, such as, e.g., under restrained spatial conditions in the case of pipe conduits with adjacently arranged trains of pipes. In practice there is accordingly a great interest in mineral wool products that combine the insulation properties of glass wool with the temperature resistance of rock wool.

A simultaneous use of proportions of glass wool and rock wool in the manufacture, e.g., of a mineral wool insulation board is known, e.g., from DE 196 12 711 A1. From this document a method for introducing additional material into a mineral wool nonwoven mat is known. Although it is possible with this method to produce a mixed mineral wool product comprising proportions of glass wool and rock wool, nevertheless in the past such mineral wool having a good insulation property on the one hand and a sufficient fire stability on the other hand has not been manufactured. The products manufactured in accordance with that method hitherto had a melting comportment comparable to a pure glass wool product, the reason being that the glass wool fibers melted under the influence of the warmth, and the wool-type structure gave way. The rock wool fibers equally present in the examined mineral wool products did not result in an enhanced refractoriness of the mineral wool products. In the case of a fire, this would have resulted in a complete collapse and tearing open of the mineral wool web exposed to the warmth.

It is therefore the object of the present invention to propose an anorganic mixed fiber product such that a product manufactured from this anorganic mixed fiber product essentially maintains its shape under the influence of temperature even at a time following melting of the glass wool fibers.

It is a further aim of the present invention to propose a method for manufacturing the anorganic mixed fiber product in accordance with the invention. Furthermore it is an aim in accordance with the invention to propose a product manufactured of an anorganic mixed fiber product in accordance with the invention, as well as an apparatus for implementing the method of the invention.

The object in accordance with the invention is attained by an anorganic mixed fiber product in accordance with claim 1. Advantageous developments of the anorganic mixed fiber product of the invention are respective subject matter of the subclaims.

The invention proposes an anorganic mixed fiber product that is preferentially suited for the manufacture of insulation material, wherein the anorganic mixed fiber product comprises at least glass wool fibers, anorganic fiber flakes, and binder. The anorganic fiber flakes in the anorganic mixed fiber product of the invention are embedded in or between the proportions of glass wool, with the anorganic fiber flakes being arranged substantially homogeneously between the glass wool fibers of the anorganic mixed fiber product. Depending on the range of proportions of the anorganic mixed fiber product, this can also involve a mineral wool.

The inventors realized that the shape and size of the anorganic fiber flakes, and the manner of their embedding in the glass wool matrix participate in the properties of the anorganic mixed fiber product of the invention like their temperature resistance. If, for instance, the anorganic mixed fiber product of the invention is heated in a trial for determining the fusion point in excess of 1000° C. or in the case of a fire, then the “mixed product” made of fibers and flakes after a certain time reaches the temperature at which the glass fibers begin to melt. Even when this temperature is exceeded, sintering effects then surprisingly occur between the melting or already molten glass wool and the anorganic fiber flakes, whereby the anorganic mixed fiber product as a whole retains its strength even above the fusion point of the glass wool fiber. In other words, a supporting structure of anorganic fiber flakes combined with sintered glass wool remains erect. Owing to this combination between “glass wool fiber” and anorganic fiber flakes as a skeleton or support, respectively, the anorganic mixed fiber product web remains clearly longer in its original shape than is currently the case with mineral wool webs containing glass wool fibers. The problem of a loss of shape or disintegration of the insulation material is thereby avoided.

Advantageous for this support effect of the anorganic fiber flakes to maintain the shape of the insulation material is their homogeneous distribution between the glass wool fibers. Such homogeneous distribution is not known in the prior art. An exemplary method whereby the demanded homogeneity of distribution may be attained is discussed in detail further below. In order to examine whether the desired homogeneity of distribution has been attained, it is possible to perform a macroscopic inspection with the unarmed eye. The two fiber types (glass wool fibers and anorganic fiber flakes) often differ in color. Glass wool fibers are colorless, anorganic fiber flakes may be brownish, for instance, if they—as one example for anorganic fiber flakes—comprise rock wool.

Particularly prior to curing of the binder it is therefore well possible to distinguish between the components with the unarmed eye, and easy to judge a distribution of the two fiber types.

For an automated examination of the distribution of anorganic fiber flakes in the final product it is possible to utilize the different light absorption behavior. Zones having an elevated proportion of anorganic fiber flakes bring about a higher light adsorption than other zones. Based on this property, for example a “transmitted light measurement” by using a VCD line camera and an assessment of the existing homogeneity based on the obtained results is possible.

In a preferred embodiment, the diameter of the anorganic fiber flakes in the raw nonwoven mat of the anorganic mixed fiber product of the invention is between 5 mm and 30 mm. In a particularly preferred manner a diameter between 8 mm and 12 mm is selected. At such a diameter of the anorganic fiber flakes there exists a particularly preferred specific surface area, for the sizes, or diameters, of the anorganic fiber flakes decisively influence the binding behavior between the molten glass wool fibers and the more resistant anorganic fiber flakes after the application of temperature.

In a further preferred embodiment, at least part of the anorganic fiber flakes contained in the anorganic mixed fiber product of the invention was obtained from corresponding recycled material. The ensuring advantages include savings of the often considerable costs for disposal of the basic raw material for the anorganic fiber flakes, which has otherwise be supplied to a recycling process, as well as high-quality utilization thereof. In the case of the material processed as anorganic fiber flakes in the anorganic mixed fiber product of the invention, costly dumping, which is subject to fees, is suppressed.

In a further preferred embodiment, the volume of the anorganic fiber flakes is about the onefold to sevenfold volume of the glass wool of the anorganic mixed fiber product, corresponding to a content by volume of the anorganic fiber flakes in the anorganic mixed fiber product of the invention of about 50% (vol.) to 87.5% (vol.). In tests conducted by the applicant, these volume ratios between glass wool and anorganic fiber flakes have found to be particularly suited for the formation of good support structures and thus for preserving the shape in the case of a fire. Moreover the anorganic mixed fiber product of the invention observing this ratio between glass wool and anorganic fiber flakes has good insulation properties in everyday life. However, should the requested temperature which above is quoted as 1000° C. be lower than 1000° C., also a content by volume of anorganic fiber flakes in the anorganic mixed fiber product of the invention of less than 50% (vol.) to 87.5% (vol.) may be sufficient and is also comprised in the invention. Such content by volume may be 10, 15, 20, 25, 30, 35, 40, 45% (vol.) or values in between.

In a further preferred embodiment, the rock wool flakes are used as anorganic fiber flakes. These elevate the temperature resistance of the anorganic mixed fiber product of the invention notably, as the skilled person knows. Rock wool flakes further show all advantages as discussed above in relation to the anorganic fiber flakes. All things discussed above also apply to rock wool flakes as anorganic fiber flakes. The same applies for the use of glass wool flakes, flakes made of E-glass fibers, flakes made of ceramics surrogate (so-called AES fibers) or ceramic fibers. The same further applies if anorganic fiber flakes containing combinations of different anorganic fiber flakes or displaying same are used (example: anorganic fiber flakes with portions of rock wool flakes and ceramic flakes).

The object of the invention is moreover attained by the method in accordance with claim 9. Advantageous developments of the inventive method are respective subject matter of the corresponding subclaims.

Thus the invention proposes a method for manufacturing an anorganic mixed fiber product of glass wool and anorganic fiber flakes, wherein the manufacture of the glass wool fiber essentially takes place by means of a TEL process. In accordance with the invention, the anorganic fiber flakes are added to the glass wool fibers in a chute, such that the anorganic fiber flakes are disposed or allotted or provided substantially homogeneously between the proportions of glass wool of the anorganic mixed fiber product. The anorganic fiber flakes are in particular mixed with the glass wool fibers by injection into the chute. All of the above represented advantages that may be attained by the anorganic mixed fiber product of the invention are also fully attained by the product obtained through the method of the invention for manufacturing this anorganic mixed fiber product. Express reference is therefore made to the above discussion of these advantages and is further made to that the anorganic mixed fiber product may be a mineral wool which may also be manufactured through the method of the invention.

The chute is the one location/area of the installation or apparatus used for manufacturing the anorganic mixed fiber product of the invention in which the glass fibers attenuated by the so-called spinner—a centrifuging ring in the TEL process—from still-liquid molten material are further attenuated, cooled, solidified, and provided with binder, before they impact at the end of the chute on a collecting conveyor, as a general rule a receiving belt, and combined into an anorganic mixed fiber product. As the anorganic mixed fiber product still has not assumed its final shape in this area, it is particularly easy to admix or supply the anorganic fiber flakes to the glass wool fibers inside the chute. In this way a homogeneous distribution of the anorganic fiber flakes between the glass wool fibers may be achieved in a particularly simple manner.

Examinations by the applicant showed that the desired, substantially homogeneous distribution of the anorganic fiber flakes between the glass wool fibers is in a particularly reliable manner achieved by injecting the anorganic fiber flakes into the chute. The reason for this is that by application of a sufficiently vigorous or suitable injection flow, the anorganic fiber flakes are injected into the depth of the cross-section of the stream of glass wool fibers and do not only mix with glass wool fibers in the respective outer ranges of the cross-section of the stream of glass fibers, for instance.

In another further preferred embodiment of the method of the invention, it is provided that the anorganic fiber flakes are brought into contact with a binder. The anorganic fiber flakes are thus combined with the glass fibers not solely by means of the binder already provided on the glass wool fibers. Preferably the anorganic fiber flakes are sprayed with the binder. Spraying of the binder is particularly suited for an application of the binder as the spraying process—in contrast with other application processes (e.g., immersing the anorganic fiber flakes in the binder)—allows an application of the binder in a desired binder thickness. Moreover by spraying the binder it is easily possible to incorporate the application process into the continuous anorganic mixed fiber product manufacturing process. This allows an application of the binder without having to interfere with particular complexity in the construction or the process flow of the frequently already existing TEL process and installation used for this purpose.

In another further preferred embodiment of the method of the invention, the anorganic fiber flakes are preferably introduced into the chute, i.e. injected into the toroid (or discharge or flock or stream, respectively) of fibers, horizontally above the area of the installation used for carrying out the method of the invention, in which the glass wool fibers are sprayed with the binder. The advantage of this embodiment is that both the anorganic fiber flakes and the glass fibers are provided with binder in a same process step. This means no additional complexity for wetting the anorganic fiber flakes with the binder. In this kind of feeding of the anorganic fiber flakes, the mixture of freshly formed glass wool fibers and anorganic fiber flakes at first passes through a range of a laminar flow which subsequently continues into turbulent flow. As the glass wool fibers and anorganic fiber flakes have a practically identical behavior in the air stream under these conditions, there results a particularly homogeneous intermingling and intense mixing. At the same time this brings about a substantially homogeneous wetting of the glass wool fibers and anorganic fiber flakes in the subsequent addition of binder. Injection of the anorganic fiber flakes must here be adjusted such that the anorganic fiber flakes penetrate into the toroid (or discharge or flock or stream, respectively) of fibers but do not penetrate through it.

Owing to the intense homogenization, the joint addition of binder for the glass wool fibers and the anorganic fiber flakes may be reduced to the necessary minimum; in particular it is not necessary to use binder beyond the measure required for reliable wetting of the anorganic fiber flakes. This reduction in use of binder brings about economic and product-specific advantages through savings of binder, higher limit temperatures of application of, e.g., 620° C., and improved comportment in fire. Thus an unnecessary development of smoke might be avoided in the case of a fire, i.e., when the anorganic mixed fiber product manufactured by the method in accordance with the invention of this embodiment is exposed to fire.

As an alternative, the binder may also be applied separately, i.e., independently of wetting the glass wool fibers with binder. The required additional complexity in terms of apparatus is offset on the one hand by the fact that, owing to the additional binder provided on the anorganic fiber flakes, an enhanced adhesion between the glass wool fibers and the anorganic fiber flakes is attained. In the anorganic mixed fiber product of the invention it is possible to purposely adjust areas of different binder contents at an altogether reduced use of binder. In addition, a second type of binder may be employed.

The respective decision is made by the skilled person based on his experience and depending on the existing overall conditions and material requirements. The explanations concerning the effects of a reduced use of binder apply analogously.

In a further preferred embodiment of the method of the invention, anorganic fiber flakes are used that are or were obtained through recycled material by means of a mat opening process, “opening up the mat.” The related advantages such as cost savings have already been discussed at the outset. In order to avoid repetitions, express reference is accordingly made in this place to the above discussion.

The object of the invention is moreover attained through a product in accordance with claim 15 that was produced by the method of the invention. As the advantages in connection with the product of the invention fully correspond to those already discussed above in connection with the method of the invention and the anorganic mixed fiber product of the invention, express reference is made in this place to the above discussion.

The object of the invention is moreover also attained through the apparatus or installation for implementing the method of the invention in accordance with claim 16. One example for such an apparatus is explained in the description of the drawings hereinbelow. As the advantages in connection with the apparatus or installation of the invention fully correspond to those already discussed above in connection with the method of the invention and the anorganic mixed fiber product of the invention, express reference is made in this place to the above discussion.

For a better understanding of the present invention it shall be explained in detail by referring to the annexed drawings, wherein:

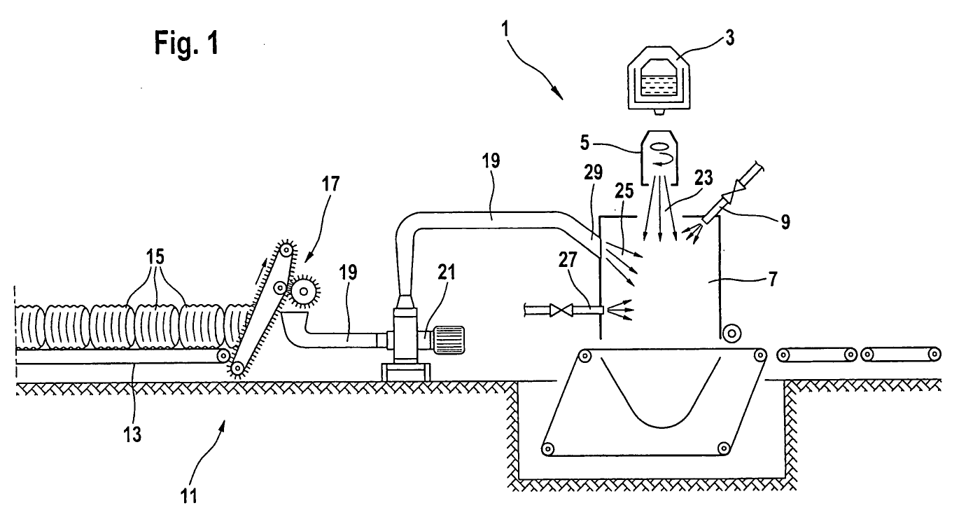

FIG. 1 shows a schematic representation of an installation for manufacturing the anorganic mixed fiber product of the invention in a manufacturing method in accordance with the invention; and

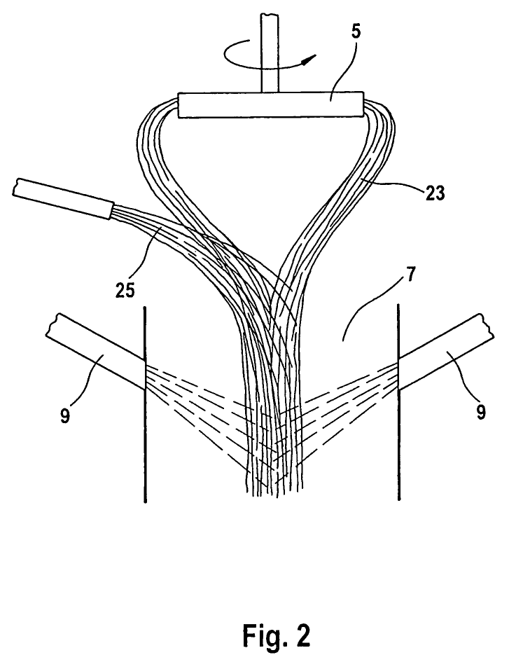

FIG. 2 shows a schematic representation of an exemplary injection of flakes into the glass wool fiber toroid (or discharge or flock or stream, respectively).

FIG. 1 shows an installation 1 in accordance with the invention for manufacturing the anorganic mixed fiber product of the invention by means of the manufacturing method in accordance with the invention. The installation 1 essentially corresponds to an installation for implementing the TEL process that is known per se, which comprises a melting end 3, a spinner or a TEL machine 5, and a chute 7. The melting end 3 serves for melting the glass constituents required for the anorganic mixed fiber product to be produced, which arrive from the melting end 3 in the molten condition in the spinner 5. Inside the spinner 5, the molten glass mass is centrifuged, after which glass fibers exit downwardly from the spinner 5 into the chute 7. To the stream or toroid 23 of the glass wool fibers, binder from a distributing organ 9 is supplied in the chute 7.

In accordance with the invention, this installation 1 comprising components 3, 5, 7 and 9, is supplemented by a feeding device 11 for feeding rock wool flakes 25 as an example for anorganic fiber flakes into the chute 7, wherein an anorganic mixed fiber product which is a mineral wool in this example is formed by feeding rock wool flakes 25 as an example for anorganic fiber flakes into the toroid 23 of the glass wool fibers. The feeding device 11 includes a transport device 13 for rock wool bales 15, where the rock wool of the rock wool bales 15 may be recycled material. The rock wool bales 15 are moved by means of the transport device 13 towards the chute in a comminuting device, or bale or mat opening means 17. In the bale or mat opening means 17, the rock wool bales are plucked apart into small flakes having an appropriate size, which subsequently drop into a feed line 19 or are sucked into it. In the feed line 19 the flakes or rock wool flakes 25 are accelerated by means of a fan or blower 21 to be injected from a mouth of the means 29 for feeding the rock wool flakes 25 into the chute 7.

The rock wool flakes 25 injected into the chute 7 are, in accordance with the schematic representation of FIG. 2 of a preferred embodiment, injected into the toroid (or discharge or flock or stream, respectively) of fibers 23 formed of freshly produced glass wool fibers at such a velocity and impulse that the toroid is not penetrated through; the rock wool flakes 25 are rather deflected in a suitable manner inside and by means of the toroid of fibers 23. For a better homogeneous distribution of the rock wool flakes 25, these may also be introduced via several feed openings. Owing to the spatial arrangement of injection or introduction in the immediate vicinity of fiberization of the proportion of glass in glass wool fibers, the introduction still takes place in the range of the laminar flow. Owing to the transition into a turbulent flow following the phase of the laminar flow, an intense mixing of glass wool fibers and rock wool flakes 25 ensues without any further intervention. By the subsequent application of binder—e.g., by means of a binder ring, here represented by two nozzles 9—a homogeneous binder distribution in the stream of glass wool fibers and rock wool flakes 25 is ensured, which results in a good reticulation of the proportions of glass wool and rock wool flakes 25 in the final product.

In the lower range of the chute 7, the product produced of glass wool and rock wool flakes 25 in the chute 7 is collected as a raw nonwoven mat (see FIG. 1) by means of a collecting conveyor, as a general rule a perforated, evacuated receiving belt, and transported to the further processing that is not represented here.

The installation 1 in accordance with the invention may moreover include additional opening means (not represented), whereby the rock wool flakes 25 obtained from the bale or mat opening means 17 are in a more finely adjustable process reliably comminuted to a predetermined flake size of, e.g., 10 mm.

As is moreover represented in FIG. 1, feeding of binder may take place not only via the nozzle 9 or a plurality of such nozzles 9. Feeding of binder is also possible via nozzles 27. The nozzles 27 are situated in accordance with the representation of FIG. 1 (when viewed in the direction of the production flow) behind the location of introduction of the rock wool flakes 25 into the chute 7. The nozzles 27 are therefore situated below the opening of the means 29 for feeding the rock wool flakes 25 into the chute 7. Such feeding of binder via nozzles 27 may take place in supplementation of the feeding from the nozzles 9 and thus in a way different from the one by means of the nozzles 9 as shown in FIG. 2. Feeding of binder solely via the nozzles 27 is also in conformity with the invention, to the extent that the desired homogeneity of distribution is preserved even with a feeding of binder changed in comparison with FIG. 2.

A use of the anorganic mixed fiber product of the invention is advantageously possible wherever the temperature properties of glass wool are not sufficient, or a fusion point in excess of 1000° C. is demanded. This is particularly true for the product groups of pipe shells, ceiling boards, ventilation conduits, and flat roof panels.

Advantageously both the glass wool fibers and the rock wool flakes are formed of mineral fibers that are soluble in a physiological medium, with these demands corresponding to the European Guideline 97/69/EC and/or to the demands of the German Hazardous Substances Regulation Sect. IV No. 22. Hereby non-hazardousness of the anorganic mixed fiber product of the invention during manufacture, processing, utilization and disposal is advantageously ensured. Exemplary compositions for a bio-soluble glass wool are indicated, e.g., in EP 0 412 878 B2, for a bio-soluble rock wool, e.g., in WO 96/16913 A1.

The present invention thus for the first time proposes an anorganic mixed fiber product having good insulation properties and good refractoriness, wherein the anorganic mixed fiber product comprises both glass fibers and anorganic fiber flakes, and wherein the anorganic fiber flakes are disposed substantially homogeneously between the glass fibers. The present invention moreover proposes a method for manufacturing the anorganic mixed fiber product of the invention, as well as an installation for implementing the method of the invention. The invention further proposes a product manufactured of the anorganic mixed fiber product of the invention.

1. Anorganic mixed fiber product, preferably for the manufacture of insulation material, which includes at least glass wool (23) in fibers, anorganic fiber flakes (25) and binder, characterized in that the anorganic fiber flakes (25) are disposed or provided substantially homogeneously between the glass wool fibers (23) of the anorganic mixed fiber product.

2. Anorganic mixed fiber product in accordance with claim 1, wherein the anorganic fiber flakes (25) have a diameter of more than 5 mm and less than 30 mm, in particular between 8 mm and 12 mm.

3. Anorganic mixed fiber product in accordance with claim 1, wherein at least part of the anorganic fiber flakes (25) was obtained from recycled material.

4. Anorganic mixed fiber product in accordance with claim 1, wherein the content by volume of the anorganic fiber flakes (25) of the anorganic mixed fiber product of the invention amounts to about 10% (vol.) to about 87.5% (vol.), particularly between 30% (vol.) and 87.5% (vol.), and even more particularly between 50% (vol.) and 87.5% (vol.).

5. Anorganic mixed fiber product according to claim 1, wherein the anorganic fiber flakes (25) comprise rock wool flakes.

6. Anorganic mixed fiber product according to claim 1, wherein the anorganic fiber flakes (25) comprise flakes made of E-glass.

7. Anorganic mixed fiber product according to claim 1, wherein the anorganic fiber flakes (25) comprise flakes made of ceramic fibers.

8. Product including an anorganic mixed fiber product according to claim 1.

9. Method for manufacturing an anorganic mixed fiber material of glass wool (23) and anorganic fiber flakes (25), preferably in accordance with claim 1, wherein the manufacture of the glass wool (23) essentially takes place in a TEL process, and wherein the anorganic fiber flakes (25) of the glass wool (23) are added into a chute (7), in particular by injecting the anorganic fiber flakes (25) into the chute (7), such that the anorganic fiber flakes (25) are provided substantially homogeneously between the glass wool fibers (23) of the anorganic mixed fiber product.

10. Method in accordance with claim 9, wherein the anorganic fiber flakes (25) are brought into contact with a binder.

11. Method in accordance with claim 9, wherein the anorganic fiber flakes (25) are sprayed with the binder.

12. Method in accordance with claim 9, wherein the anorganic fiber flakes (25) are introduced into the chute (7) above the range in which they are sprayed with the binder.

13. Method in accordance with claim 9, wherein the anorganic fiber flakes (25) and the glass wool fibers (23) are jointly wetted with binder.

14. Method in accordance with claim 9, wherein the anorganic fiber flakes (25) were obtained by opening up recycled material.

15. Product which was manufactured by a method in accordance with claim 9.

16. Apparatus (1) for carrying out the method in accordance with claim 9 in a TEL process, wherein the apparatus (1) respectively comprises at least a melting end (3), a spinner (5), and a chute (7), characterized in that the apparatus (1) further includes a feeding device (11) for anorganic fiber flakes (25) in the at least one chute (7).

17. Apparatus in accordance with claim 16, comprising a device (17) for producing the anorganic fiber flakes (25).
